(19) United States
(12) Patent Application Publication
(10) Pub. No.: US 2008/0022548 A1
(43) Pub. Date: Jan. 31, 2008

(54) Treatment Process

(76) Inventors: Nigel Paul Maynard, Auckland (NZ); Anthony John Bergervoet, Auckland (NZ)

Correspondence Address: FISH & RICHARDSON PC, P.O. BOX 1022, MINNEAPOLIS, MN, 55440-1022, US

(21) Appl. No.: 10/580,160

(22) PCT Filed: Nov. 19, 2004
(86) PCT No.: PCT/NZ04/00295

§ 371 Date: Mar. 13, 2007

(30) Foreign Application Priority Data
Nov. 19, 2003 (NZ) 529640

(51) Int. Cl. F26B 3/347; F26B 7/00

(52) U.S. Cl. 34/396; 34/255; 34/257; 34/402; 34/403; 34/405

(57) ABSTRACT

A method of conditioning an organic substrate is described The method involves heating the substrate using RF energy under desired pressure conditions in a constrained environment At a desired time point, the pressure is rapidly reduced causing any water present in the substrate to rapidly boil and convert to steam.

### FIELD

This invention relates to methods of conditioning organic substrates. In particular, the invention relates to methods of conditioning lignocellulosic substrates. The conditioning may be for the purpose of facilitating subsequent impregnation of the substrate with preservatives or like compositions.

### BACKGROUND

Lignocellulosic material, and more specifically debarked logs or sawn lumber, largely because these are of biological origin, are prone to attack by organisms such as bacteria, insects, nematodes and a variety of fungi including decay and staining fungi. Such attack reduces the service life of logs or lumber extracted there from, degrades the appearance of the logs or lumber, and reduces the service life of such materials with resultant cost of replacement or potential hazard due to failure.

Logs, or lumber, when freshly cut, generally are not contaminated internally by fungi or insects. However, subsequent to felling these become vulnerable to attack by insects and fungi, particularly decay fungi. These can degrade these substrates relatively quickly depending on the species concerned.

To mitigate degradation by biological pests, methods have been developed to treat these substrates with a variety of chemicals by various physical processes.

Whilst it is possible to impregate lignocuic material such as lumber products with preservatives and like compositions, by a number of variations of vacuum and pressure cycles, these are generally restricted to treatment of the dry substrate because free space must be available within the substrate to receive the composition. This necessitates prior drying and this can be time consuming and/or expensive. Similarly such processes necessarily include injection of large volumes of solvent which must later be removed by a drying process. Use of such solvents also necessitates storage of large volumes of potentially toxic fluid.

Another method, for use with green substrates (thus avoiding the necessity for drying), utilises a process wherein the green substrate is conditioned in a steam autoclave and, after a subsequent period of cooling and moisture equilibration, the substrate is treated by alternating pressure and vacuum cycles. In this steam conditioning process, green substrates are treated with heat directly using a condensing medium, such as live steam, in an autoclave where the pressure can be maintained at up to 30 pounds per square inch over pressure. The substrate is heated to the required temperature, preferably above 100 Celsius, at elevated pressure. Upon reaching the required temperature the autoclave is vented allowing the pressure to drop rapidly and thus allowing the water to boil and the moisture to escape as steam.

During the early part of this process the steam may be present as a vapour or condensed as a liquid phase. The latter is not preferred because it is highly contaminated by wood extractives. In the later part of the process the water present is entirely in the gaseous state.

In this steam conditioning process radial cells in the substrate material, known as ray cells or parenchyma, are also emptied by the internal pressure. This then provides an avenue through which the preservative solution can enter when subsequently applied.

There are several disadvantages to this steam conditioning process for treating green substrates. For example, as the substrate begins at ambient temperatures, there is substantial condensation of the steam on the substrate and this becomes contaminated with wood extractives. The volume of condensate becomes significant, is highly contaminated, and is expensive to dispose of. The formation of condensate at the wood-steam interface may also interfere with heat transfer, especially where it does not drain away. Also, the condensate will consume steam in the chamber thus creating further condensate. Where condensate removal is ineffective, part or all of the substrate may become flooded with condensate rather than steam, thus compromising the conditioning process. In addition, generally, means of condensate removal will entail loss of steam from the chamber.

Further disadvantages include the heating process being slow because it relies entirely on heat conduction from outside the substrate to the centre of the substrate and when heated for long periods at temperatures of 130° C. which is typical of such processes, the substrate loses significant physical strength This lengthy heating step thus degrades the physical properties of the substrate. This effect is exacerbated because to get energy flow to the centre of the substrate requires a high temperature gradient. Thus the surface of the substrate may be at 130° C. whereas the centre may have only reached 100° C. at the end of the process. Since strength degradation is significantly greater at 130° C. than at 100° C., the-outer parts of the substrate are degrading whilst the centre is coming up to temperature. For example, large diameter poles may be heated for up to 15 hours with the temperature external to the pole being at 130° C. This can significantly degrade the strength of the pole.

U.S. Pat. No. 6,596,975 to Vinden and co-workers relates to a method for increasing the permeability of wood which comprises subjecting wood with a moisture content (based on dry weight) of at least 15% to microwave radiation at a frequency in the range of from about 0.1 to about 24 GHz. Such microwaves may be used for small pieces only because penetration is directly proportional to wave length. Microwaves at a commercial frequency of 2.45 GHz for example have a wave length of 0.12 metres and at 24 GHZ the wavelength is 1.25 centimeters and is therefore unsuitable for large chambers or large volumes of wood.

The process of Vinden provides no pressure constraint, therefore as the temperature rises the pressure will be continuously venting and therefore the bulk of the substrate can not be maintained for any length of time at a temperature of 100° C. or greater.

Radio frequency heating at a commercial frequency of 27 MHz which has a penetration of several metres has been used to dry lumber. This technology uses continuous venting of moisture vapour to aid in the drying process. Thus there is no pressure build up and temperatures are kept relatively low.

### OBJECT OF THE INVENTION

It is an object of the invention to provide an alternative process for conditioning organic substrates, such that the substrate is amenable to concurrent or subsequent treatment, that overcomes or ameliorates at least some of the prior art problems. It is an alternative object to provide the public with a useful choice.

### STATEMENT OF THE INVENTION

In one aspect, the present invention includes a method of conditioning an organic substrate, the method including the steps of:

(a) Subjecting the substrate to RF energy in a constrained environment for a time sufficient to heat at least part of the moisture contained in the substrate to a temperature of or above the boiling point of water at ambient pressure;

(b) Reducing pressure in the constrained environment in a manner causing the moisture within the substrate to boil and/or evaporate.

Preferably the RF energy is at a frequency between about 10 and 100 MHz. More preferably between about 27 and 40 MHz. In an alternative embodiment, the RF energy is at a frequency of up to 900 MHz.

In one preferred aspect, the pressure in the constrained environment is above atmospheric. For example, the pressure may be between about 0.5 psi and 40 psi. More preferably, the pressure is between about 3 psi and 30 psi, even more preferably between about 6 psi and 25 psi.

Preferably the temperature achieved within the substrate is between 100 and 130° C.

Preferably the pressure in the constrained environment is reduced by rapid venting. Alternatively, the pressure is reduced by rapidly applying or producing a vacuum. Alternatively, the pressure is reduced by a combination of venting and applying a vacuum.

Preferably the substrate contains sufficient moisture to allow a substantial loss thereof by means of the method of the invention.

Preferably the substrate is a lignocellulosic material. More preferably the substrate is wood.

Preferably the lignocellulosic material has a moisture content of more than 60% based on dry weight of the material; preferably greater than 100%.

Alternatively, the moisture content is less than 30% based on dry weight of material.

Preferably the method further comprises the step of storing the substrate to allow the temperature and moisture in the substrate to equilibrate following the step of reducing the pressure.

Preferably the substrate is concurrently or subsequently impregnated with a composition.

Preferably in one aspect the composition is an aqueous solution that preferably contains polar and/or non polar solvents; pesticidal or preservative components; and/or polymeric or pre-polymeric components.

Preferably in one aspect the composition is a volatile pesticidal or preservative component; and/or pre-polymeric component.

In another aspect, the invention includes a conditioning method comprising at least the steps of:

(a) Subjecting a substrate to RF energy in a constrained environment for a time sufficient to heat at least part of the moisture contained in the substrate to a temperature of or above the boiling point of water at ambient pressure;

(b) incorporating into a void or space surrounding the substrate in the constrained environment, a composition which may impart sterilisation, preservative, or property modifying aspects; and

(c) reducing pressure in the constrained environment to allow the moisture within the substrate to boil and/or evaporate.

In another aspect, the invention includes a conditioning method comprising at least the steps of:

a) Subjecting the substrate to RF energy in a constrained environment initially at substantially ambient pressure for a time sufficient to heat at least part of the moisture contained in the substrate to a temperature below the boiling point of water at ambient pressure; and

b) Reducing pressure in the constrained environment by applying or producing a vacuum in a manner causing the moisture within the substrate to boil or evaporate.

In another embodiment, the invention may be seen to comprise an organic substrate, preferably a lignocellulosic substrate that has been conditioned according to the method of the invention, preferably the substrate will have been concurrently or subsequently impregnated with a composition as well.

### DESCRIPTION OF THE INVENTION

The following is a description of the preferred forms of the invention given in general terms in relation to the application of the present invention. While the description focuses particularly on the delivery of composition in lumber or logs, it should be appreciated that the method may be applicable to other substrates.

In general terms, the invention relates to methods of conditioning an organic substrate, and, preferably a lignocellulosic substrate. The method generally involves heating a substrate in a constrained environment using RF energy and at a desired time point rapidly reducing pressure causing water or moisture present in the substrate to boil and convert to steam. This creates substantial pressure within the substrate which forces remaining water and cellular debris to be ejected from the substrate. This creates voids within the substrate and also clears pathways into the substrate sufficient for subsequent treatment with desired compositions.

The conditioning method of the invention may be used to condition a substrate for subsequent delivery of a liquid composition. If the composition is to be applied to the substrate when the substrate is at a temperature higher than ambient then the components of the composition will preferably be non-volatile at the temperature of the substrate at the time of application of the composition. One preferred form of the invention is to utilise RF energy to heat a substrate in a constrained environment followed by rapid reduction in pressure within the environment, transfer of that substrate to dry storage, and then transfer of the substrate to a pressure vessel where impregnation with preservative or like composition can be undertaken using variations of vacuum pressure cycles if desired. Of course one may use alternative means of delivering of a composition to a substrate as may be known in the art.

To this extent the invention in one aspect includes the coupling of the conditioning step with the step of subsequently delivering a desired composition to the substrate, preferably impregnating the substrate with the desired composition.

The conditioning method of the invention may also be used to condition a substrate for concurrent delivery of a composition. If the composition is to be applied to the substrate when the substrate is at temperature higher than ambient then the components of the composition may be volatile at the temperature of the substrate at the time of application of the composition.

Persons generally skilled in the art to which the invention relates will no doubt appreciate various compositions that may be applicable in a process of this aspect of the invention. However, by way of example, where treatment or prevention of infection or pre-infection by pest organisms is desired, compositions (biocide compositions) having pesticidal (fungicidal, bactericidal, insecticidal for example) or preservative properties may be used. Where it is desired that the substrate has increased density or strength properties, compositions containing polymeric or pre-polymeric components may be useful. Similarly compositions may include those of use in water-proofing a substrate. Additionally compositions containing certain dyes to colour the substrate may be used. The compositions will preferably be an aqueous solution and may contain polar and/or non polar solvents and the like for example alcohol and vegetable oils.

“Pests” or “pest organisms”, as referred to herein may include any organisms which may infect an organic substrate such as wood. While the invention is particularly applicable to fungi, pest organisms may also include bacteria, insects, nematodes and the like.

When used herein the term “treatment” should be taken in its broadest possible context. For example, when used in relation to treatment of infection by pests it should not be taken to imply that a substrate has been treated such that pest organisms are totally removed, although this would be preferable. Prevention and amelioration of growth of pest organisms is also encompassed b the invention.

It is therefore one preferred embodiment of the invention to utilise RF energy to heat a substrate, preferably a green substrate, in a constrained environment followed by rapid reduction (preferably release) of the pressure within the environment at a suitable time, transfer of that substrate to a pressure vessel where impregnation with preservative or like composition can be undertaken using variations of vacuum pressure cycles if desired. In an alternative form of this embodiment, the substrate is retained in the chamber or vessel in which it is heated and concurrently impregnated or treated with a preservative or like composition.

In one preferred embodiment, the conditioning method will include the steps of:

(a) subjecting a substrate (and preferably a green substrate) to RF energy in a constrained environment for a time sufficient to heat moisture contained in the substrate sufficient to raise the temperature within the substrate to above the boiling point of water at ambient pressure; and

(b) reducing pressure in the constrained environment to allow the moisture within the substrate to boil and/or evaporate.

In another preferred embodiment the invention includes a conditioning method comprising at least the steps of:

a) subjecting a substrate to RF energy in a constrained environment for a time sufficient to heat moisture contained in the substrate sufficient to raise the temperature within the substrate above the boiling point of water at ambient pressure;

b) incorporating into the void surrounding the substrate in the constrained environment, a composition which may impart sterilisation, preservative, or property modifying aspects; and

c) reducing pressure in the constrained environment to allow the moisture within the substrate to boil and/or evaporate.

The temperature and moisture can then be allowed to equilibrate prior to proceeding with another treatment process, such as impregnation with a composition, or machining and the like.

In another preferred embodiment, the invention includes a conditioning method comprising at least the steps of:

a) Subjecting the substrate to RF energy in a constrained environment at substantially ambient pressure for a time sufficient to heat at least part of the moisture contained in the substrate to a temperature below the boiling point of water at ambient pressure; and

b) Reducing pressure in the constrained environment by applying or producing a vacuum in a manner causing the moisture within the substrate to boil or evaporate.

As used herein, “organic substrate” should be taken to mean any organic material which may be in need of conditioning and/or delivery of a composition of some nature. Such substrate is preferably lignocellulosic, for example, wood products, lumber or logs. The only requirement is that there is sufficient moisture capable of being evaporated by the energy imparted by the RF energy used subsequent to reduction in pressure in the constrained environment. While single pieces of lumber could be treated by the inventive process, it is envisaged that treatment of a number of pieces consolidated into a packet or bunch, perhaps 200 pieces or more, may also be treated by the present process. These might comprise sawn lumber, poles or logs for example.

In the case of lignocellulosic substrates, those which “contain a level of moisture” include freshly felled and debarked logs or freshly sawn lumber (so called green lumber). Those of general skill in the art to which the invention relates will be aware that freshly felled logs or freshly sawn lumber may contain approximately 150% of their dry weight as moisture if soft wood and approximately 80% if hard wood.

A constrained environment is any ‘chamber’ which may be substantially sealed against pressure drop at least during the heating process of the invention. In a particularly preferred embodiment of the invention the pressure in the constrained environment is actively supplemented or increased above atmospheric pressure such that the boiling point of water within the substrate is raised above 100° C. By way of example, the pressure may be between about 0.5 psi and 40 psi, more preferably between about 3 psi and 30 psi, even more preferably between about 6 psi and 25 psi. However, the heating step of the invention may be conducted under atmospheric or ambient pressure conditions in certain circumstances. In this instance, the pressure within the constrained environment may initially be at ambient pressure but during the heating step may slightly increase above atmospheric pressure.

Typically such a ‘chamber’ is cylindrical as is common with pressure vessels. Such chambers will be well known to a skilled person in this field. Typically suitable autoclaves can be used. If the process of the invention operates at a lower temperature (close to 100 Celsius) the over pressure might only be a few psi, in which case almost any chamber could be used as long as the desired pressure can be constrained or maintained within the chamber. Person's of general skill in the art to which the invention relates will readily appreciate various other appropriate chambers or vessels for use in creating an environment in accordance with a method of the invention.

Reducing or releasing pressure in the constrained environment can occur by any means known in the art. In one preferred embodiment of the invention it occurs by releasing the constrained environment such that gases can escape. By way of example, it may occur by venting. Typically a series of large diameter gate valves or butterfly valves may be utilised. In another preferred form of the invention pressure reduction occurs by applying or producing a vacuum. Producing or applying a vacuum may provide a sufficient pressure drop where the constrained environment is at or about atmospheric pressure during the heating step; in this case the vacuum conditions will lower the boiling point of water contained in the substrate. Applying or producing a vacuum may also be used to provide a pressure reduction in the instance that the heating phase is conducted well above atmospheric pressure. Further, a vacuum may be applied during or preferably immediately subsequent to the likes of venting of the constrained environment. This may enhance the speed of pressure reduction.

As used herein the terms “applying a vacuum” or “producing a vacuum” should not be taken to imply that the constrained environment, for example a chamber, is completely evacuated of air or other gases. In accordance with the invention, all that is required is a drop in pressure within the chamber sufficient to rapidly boil water present in the substrate.

Reduction in pressure in the constrained environment should occur rapidly, and preferably abruptly, to enhance the boiling effect.

The period of time the substrate is subjected to the RF energy is preferably a time sufficient to heat the substrate uniformly and to an appropriate temperature. In one preferred embodiment, where the pressure in the constrained environment is above atmospheric or ambient pressure, the time will be sufficient to heat the moisture within the substrate to a temperature of greater than the boiling point of water at ambient pressure. Preferably the temperature created should be one which is sufficient to elevate moisture temperature within the substrate to at least 100° C. Where the pressure of the constrained environment is above atmospheric, it should be appreciated that the boiling point of water will be elevated. In such conditions temperatures may well exceed 100° C. without any water boiling. For example, at a pressure of approximately 24 psi the boiling point of water will be approximately 130° C., and at approximately 6.1 psi, the boiling point of water will be approximately 110° C. Under such pressure conditions at a time and temperature decided upon, the pressure constraint can be removed allowing the moisture to boil initially at a temperature substantially above 100° C.

In another embodiment, where the pressure in the constrained environment is at about atmospheric or ambient pressure, the heating time should be sufficient to heat the moisture within the substrate to a temperature of below the boiling point of water at ambient pressure. Under such pressure conditions at a time and temperature decided upon, the pressure can be reduced allowing the moisture to boil at a temperature below 100° C. For example, water will boil at approximately 65.6° C. if the guage pressure is reduced to minus 11 psi (−75.7 kPa).

It should be appreciated that temperatures and times sufficient to heat the substrate may vary depending upon factors such as the nature of the substrate, the frequency of the RF energy, and the temperature ultimately required. The phrase “sufficient to heat” does not imply that the conditioning process must be sufficient to completely rid the substrate of moisture. The inventor contemplates a reduction in any moisture and enhancement of penetrative pathways being appropriate in respect of the invention.

As used herein the terms “ambient pressure” or “atmospheric pressure” should be taken to mean ambient atmospheric pressure at the location at which the method is being performed.

In a preferred embodiment of the invention the RF energy applied is in the low frequency range (between about 10 and about 100 MHz). More specifically, frequencies of approximately 27 to 40 MHz are particularly desirable. At this range, batches of two or more separate pieces of a substrate, for example two or more logs of lumber may be treated simultaneously. In a commercial operation this may involve treatment of perhaps 30 cubic metres of logs or lumber. The invention is preferably applied to batch processing.

Whilst packets of lumber may be 2 or 3 metres in length some may be longer (for example, poles may be 10 metres long or more). To ensure penetration throughout such a packet, long wavelength energy must be used otherwise it will be absorbed only superficially. For example, RF energy at 27 MHz has a wavelength of over 11 metres thus the energy will be distributed adequately throughout the substrate ensuring that moisture in the substrate is mobilised as discussed earlier.

It should be appreciated that in instances where a single piece of wood is desired to be conditioned by a method of the invention, RF energy of frequencies of approximately up to 900 MHz may be suitable.

In a particular embodiment of the invention, a substrate with relatively high moisture content, for example green lumber with a moisture content of greater than 100% (approximately 150%) based on dry weight, would be heated using low frequency RF energy whilst under constraining pressure. In such a case the heating would heat the moisture within the substrate sufficiently to exceed the boiling point of water. Upon rapid venting of pressure this would enable the water to boil and escape the substrate as steam resulting in the creation of voids in the substrate. Subsequently, if the temperature of the substrate is at or about ambient then vacuum pressure techniques may be used to impregnate the substrate preferably with a liquid composition. This impregnation can be assisted by use of vacuum/high pressure techniques particularly when the temperature differential is not sufficient to ensure adequate impregnation without assistance. It would be an advantage if the composition itself had properties which allowed it to penetrate the substrate to some extent (as opposed to just sitting on its surface following application).

Whereas other techniques may take up to 15 hours to adequately precondition the substrate, because the heating phase relies entirely on conduction, the process of this invention can achieve the same target temperature within 3 hours or less depending on the energy available. Because the heating is throughout the substrate during the process the only constraint on time is the energy available from the RF source.

Several processes are available to impregnate substrates using vacuum/pressure systems. Such vacuum and pressure cycle variations include Reuping, Lowry and Full Cell processes. These processes are adequately described in “Industrial Timber Preservation”, 1979, J G Wilkinson, Associated Business Press. Any process to impregnate a substrate preconditioned by the method of the present invention could be used as desired. The method of the invention facilitates the impregnation of such substrates as is discussed earlier herein.

The invention further extends to organic substrates that have been preconditioned according to the process of the invention and also to organic substrates that have been preconditioned by the process of the invention and then impregnated with a composition as desired.

### EXAMPLES

The invention will now be further described with reference to the following non-limiting examples.

### Method—Green Substrate

The inventors envisage one or more variations of a process wherein the substrate is constrained in the chamber and an over pressure applied and the substrate heated using low frequency RF energy. Two options include an over pressure supplied from an external source, and an over pressure created within the process itself.

### Example 1

Green lumber is placed in an autoclave and the doors closed to create a constrained environment. An over pressure within the autoclave is applied from an external source. This can be any gas and is most economically air. In a preferable example the pressure is raised to approximately 24.5 psi. Energy is then applied in the form of radio frequency energy preferably at a frequency preferably below 100 MHz and more preferably at 27 or 40 MHz, thus immediately heating the substrate, and without need for venting of gases or slow heat up. No condensate is created in this process because no live steam is applied and because any water within the substrate is constrained. After a time when sufficient energy has been applied to achieve the desired temperature throughout the substrate, typically between 100 and 130° C., the pressure is rapidly released (for example, the autoclave is rapidly vented) whereupon water within the substrate will boil causing evaporative loss and clearing the substrate of cellular debris as also occurs in the traditional steaming process: The evaporative loss may be further enhanced by application of a vacuum.

In another aspect this process might include addition, in the gaseous phase, of volatile biocide components which may then impart a sterilising or preserving action to the substrate and/or pre-polymeric components which might then impart a change to the physical properties of the substrate. For example, it is known to those versed in the art that biocides such as orthophenylphenol or the like have a relatively high vapour pressure which increases with temperature. Inclusion of this in the present invention can impart beneficial properties to the substrate. Similarly boric acid is volatile in the presence of gaseous water and could thus be presented to the substrate by the process of this invention thus eliminating the need for a liquid or vapour solvent phase. Further it is also known that the rate of diffusion of such biocides within the substrate is significantly enhanced as temperature rises. Thus once incorporated in or on the surface of the substrate the elevated temperature will facilitate diffusion into the interior of the substrate. In particular where the biocide is conducted within the liquid phase within the substrate it can be important to maintain the liquid phase by an over pressure during this process. This can be otherwise unachievable due to evaporative loss if the over pressure is not present. It should be appreciated that the use of steam to carry biocidal components (or the use of other volatile components) is not part of the heating step, but is rather a means of providing the biocidal components to the substrate.

The substrate is then moved to temporary storage to allow cooling or moisture equilibration.

Following storage, the lumber is again transferred to allow application of the preservative composition of choice. The composition can be applied using known techniques and impregnation can be assisted or achieved using known vacuum/high pressure techniques as available.

### Example 2

Green lumber is placed in an autoclave which is then hermetically sealed to create a constrained environment. No initial overpressure is applied, but as energy is then applied in the form of radio frequency energy preferably at a frequency below 100 MHz and more preferably at 27 or 40 MHz, an overpressure develops in the autoclave from steam generated by direct heating of the substrate and thermal expansion of air in the autoclave and the wood by indirect heating. Some condensate is created during pressure development but is minimal compared to conventional steaming or kiln conditioning and will revert to a gas as the temperature within the autoclave rises.

As described in example 1, biocides, pre-polymers and other components can be included in the gaseous or vapour phase enclosing the substrate.

After a time when sufficient energy has been applied to achieve the desired temperature throughout the substrate, typically 100 to 130 Celsius, the pressure is rapidly released whereupon water within the substrate will boil causing evaporative loss and clearing the substrate of certain cellular debris as occurs for the traditional steaming process. This evaporative loss may be further enhanced by application of a vacuum.

The substrate can be moved to temporary storage and treated as referred to in Example 1.

### Further Examples

The invention relies on reduction in pressure within a constrained environment following heating with RF energy. Accordingly, examples 1 and 2 could also be achieved by application of RF energy at ambient pressures with an abrupt application of a vacuum. In this case, the temperature of the moisture in the substrate should not exceed the boiling point of water at ambient or atmospheric pressure. In this instance such vacuum will need to be applied while maintaining the constrained environment. This could occur in appropriate chambers such as in an autoclave or vacuum vessel.

Further examples would be as for examples 1 and 2, but wherein the moisture content of the substrate is lower, typically below 30 percent, in which case the additional compositions such as biocides or pre-polymeric components may in part diffuse into the substrate in a gaseous phase due to the lower substrate moisture content.

The benefits of the process of the invention can be any one or more of:

Significant reduction of liquid waste streams and the cost of disposal thereof because there is no condensate from steam.

Elimination of the pre-heat air flushing period thus saving significant time and energy cost.

A significant reduction in heating time because energy is transferred directly throughout the substrate.

A reduction in strength loss because there is a significant reduction of time at the elevated temperature.

A reduction in strength loss because the substrate may be processed at lower average temperature.

Lower energy consumption because less energy is wasted by elimination of the heat up period and more efficient energy transfer.

Elimination of energy required for heating the metal autoclave and bogies for carrying the substrate because these are inert to RF energy.

A significant reduction in processing time because the rate of heating does not depend on conduction.

Overall the process is significantly simplified, energy costs are lowered and waste streams substantially reduced. The total period for the process is entirely related to the rate of energy input not to the conductivity of the substrate. Therefore if sufficient RF energy is available the process time can be significantly shortened.

Thus we envisage a fast energy efficient process and which eliminates a number of problems and costs normally associated with preservation of logs, poles or lumber.

The foregoing includes a disclosure of the invention including preferred forms thereof. Alterations or modifications that would be readily apparent to the skilled person are intended to be included within the scope of the invention. References to prior art herein, unless otherwise stated, does not constitute an admission that such art constitutes common general knowledge in New Zealand or any other country.

1. A method of conditioning a substrate, the method including the steps of:
a) subjecting the substrate to RF energy in a constrained environment for a time sufficient to heat at least part of the moisture contained in the substrate to a temperature of or above the boiling point of water at ambient pressure; and
b) reducing pressure in the constrained environment in a manner causing the moisture within the substrate to boil or evaporate.

2. A method as claimed in claim 1 wherein the RF energy is at a frequency between about 10 and 100 MHz.

3. A method as claimed in claim 2 wherein the RF energy is at a frequency between about 27 and 40 MHz.

4. A method as claimed in claim 1 wherein the pressure in the constrained environment is above atmospheric.

5. A method as claimed in claim 4 wherein the pressure is between approximately 0.5 psi and 40 psi.

6. A method as claimed in claim 5 wherein the pressure is between approximately 3 psi and 30 psi.

7. A method as claimed in claim 6 wherein the pressure is between approximately 6 psi and 25 psi.

8. A method as claimed in claim 1 wherein the pressure in the constrained environment is at atmospheric pressure.

9. A method as claimed in claim 1 wherein the temperature achieved within the substrate is between 100 and 130 C.

10. A method as claimed in claim 1 wherein the pressure in the constrained environment is reduced by venting.

11. A method as claimed in claim 1 wherein the pressure is reduced by applying or producing a vacuum.

12. A method as claimed in claim 1 wherein the pressure is reduced by a combination of venting and applying or producing a vacuum.

13. A method as claimed in claim 1 wherein the substrate is a lignocellulosic material.

14. A method as claimed in claim 13 wherein the substrate is wood.

15. A method as claimed in claim 13 wherein the lignocellulosic material has a moisture content of more than 60% based on dry weight of the material.

16. A method as claimed in claim 15 wherein the moisture content is greater than 100% based on dry weight of the material.

17. A method as claimed in claim 15 wherein the moisture content is less than 30% based on dry weight of the material.

18. A method as claimed in claim 1 wherein the method further comprises the step of storing the substrate to allow the temperature and moisture in the substrate to equilibrate.

19. A method as claimed in claim 1 wherein the substrate is concurrently or subsequently impregnated with a composition.

20. A method as claimed in claim 19 wherein the composition is an aqueous solution that contains polar and/or non polar solvents, pesticidal or preservative components, and/or polymeric or pre-polymeric components.

21. A method as claimed in claim 19 wherein the composition contains a volatile pesticidal or preservative component and/or pre-polymeric component.

22. A conditioning method comprising at least the steps of:
a) subjecting the substrate to RF energy in a constrained environment at substantially ambient pressure for a time sufficient to heat at least part of the moisture contained in the substrate to a temperature below the boiling point of water at ambient pressure; and
b) reducing pressure in the constrained environment by applying or producing a vacuum in a manner causing the moisture within the substrate to boil or evaporate.

23. A conditioning method comprising at least the steps of:
a) subjecting the substrate to RF energy in a constrained environment for a time sufficient to heat at least part of the moisture contained in the substrate to a temperature of or above the boiling point of water at ambient pressure;
b) incorporating into the void surrounding the substrate in the constrained environment, a composition which may impart sterilisation, preservative, or property modifying aspects; and
c) reducing pressure in the constrained environment to allow the moisture within the substrate to boil and/or evaporate.

24. A substrate that has been conditioned according to a method of claim 1.

25. A substrate as claimed in claim 24 wherein the substrate is a lignocellulosic material or wood.

26. (canceled)

27. A substrate that has been conditioned according to a method of claim 22.

28. A substrate that has been conditioned according to a method of claim 23.

29. A substrate as claimed in claim 27 wherein the substrate is a lignocellulosic material or wood.

30. A substrate as claimed in claim 28 wherein the substrate is a lignocellulosic material or wood.
